(19) United States
(12) Patent Application Publication
(10) Pub. No.: US 2023/0074587 A1
(43) Pub. Date: Mar. 9, 2023

(54) PARKING ASSISTANCE DEVICE, PARKING ASSISTANCE METHOD, AND NON-TRANSITORY COMPUTER READABLE TANGIBLE STORAGE MEDIUM FOR STORING PARKING ASSISTANCE PROGRAM

(71) Applicant: DENSO CORPORATION, Kariya-city (JP)

(72) Inventors: Takamasa HIDAKA, Kariya-city (JP); Koudai YAMAURA, Kariya-city (JP); Masatake WADA, Kariya-city (JP)

(21) Appl. No.: 17/988,732

(22) Filed: Nov. 16, 2022

Related U.S. Application Data
(63) Continuation of application No. PCT/JP2021/017065, filed on Apr. 28, 2021.

(30) Foreign Application Priority Data
May 20, 2020 (JP) 2020-088083

(51) Int. Cl. G08G 1/0967; B60W 30/06; B60W 60/00; B60W 50/00

(52) U.S. Cl. CPC G08G 1/096725; B60W 30/06; B60W 60/0011; B60W 50/00; B60W 2050/0026

(57) ABSTRACT

A parking assistance device includes: an order table configured to record an order of setting the guide routes for autonomous vehicles; a guide calculation unit that calculates the guide routes; a re-calculation unit that re-calculates, in accordance with the order, the guide routes for vehicles among the autonomous vehicles for which the guide routes not overlapping with each other cannot be calculated; a guide setting unit configured to: set the guide routes for vehicles among the autonomous vehicles for which the guide routes not overlapping with each other can be calculated; and not set the guide routes for the vehicles for which the guide routes not overlapping with each other cannot be calculated; a route transmission unit that transmits the set guide routes to the autonomous vehicles; and an order change unit that changes the order.

### CROSS REFERENCE TO RELATED APPLICATIONS

This application is a continuation application of International Patent Application No. PCT/JP2021/017065 filed on Apr. 28, 2021, which designated the U.S. and claims the benefit of priority from Japanese Patent Application No. 2020-088083 filed on May 20, 2020. The entire disclosure of all of the above application is incorporated herein by reference.

### TECHNICAL FIELD

The present disclosure relates to a parking assistance device, a parking assistance method, and a non-transitory, computer readable tangible storage medium storing a parking assistance program configured to assist in parking a vehicle.

### BACKGROUND ART

When a parking assistance device disposed on a parking lot side transmits a command to an autonomous vehicle, a technique in that the autonomous vehicle travels between a getting-in/getting-out area where a user gets in and out and a parking area where the autonomous vehicle is parked, in accordance with the command. There has been known a technique in which, when there is a vehicle that intends to enter into the parking area from the getting-in/getting-out area and a vehicle that intends to exit from the parking area into the getting-in/getting-out area, the vehicle that intends to exit is given priority to travel.

### SUMMARY

According to a first aspect of the present disclosure, a parking assistance device is configured to assist in parking a plurality of autonomous vehicles in a parking lot. Each of the plurality of autonomous vehicles are capable of performing autonomous driving in accordance with a guide route to a target position in the parking lot. The device includes: an order table configured to record an order of setting the guide routes for the plurality of autonomous vehicles; a guide calculation unit configured to calculate the guide routes for the plurality of autonomous vehicles; a re-calculation unit configured to re-calculate, in accordance with the order recorded in the order table, the guide routes for vehicles among the autonomous vehicles for which the guide routes not overlapping with each other cannot be calculated; a guide setting unit configured to: set the guide routes for vehicles among the autonomous vehicles for which the guide routes not overlapping with each other can be calculated; and not set the guide routes for the vehicles for which the guide routes not overlapping with each other cannot be calculated; a route transmission unit configured to transmit the set guide routes to the autonomous vehicles; and an order change unit configured to change the order recorded in the order table in accordance with a circumstance parameter indicative of at least one of a circumstance on the parking lot or a circumstance on each of the autonomous vehicles. The order change unit is configured to adopt, as the circumstance parameter, an unset time indicative of a waiting time during which the guide route for each of the autonomous vehicles cannot be set. The order change unit is configured to advance the order of setting the guide route for an autonomous vehicle when the unset time for the autonomous vehicle is equal to or greater than a predetermined time threshold.

### BRIEF DESCRIPTION OF DRAWINGS

FIG. 1 is a top view showing an example of a parking lot.

FIG. 2 is a block diagram showing a configuration of a parking assistance system.

FIG. 3 is a functional block diagram of a control unit in a management device.

FIG. 4 is a flowchart of a parking setting process executed by the management device.

FIG. 5 is a flowchart of an entering order setting process in the parking setting process.

FIG. 6 is a flowchart of a setting change process in the entering order setting process.

FIG. 7 is an explanatory diagram showing an example of a condition table.

FIG. 8 is an explanatory diagram showing an example of an order table.

FIG. 9 is a flowchart of an automatic parking process executed by an autonomous vehicle.

FIG. 10 is a flowchart of an exiting setting process executed by the management device.

FIG. 11 is a flowchart of a non-overlapping exiting process in the exiting setting process.

FIG. 12 is a flowchart of an automatic exiting process executed by the autonomous vehicle.

FIG. 13 is an explanatory diagram showing an example of a node and a link.

FIG. 14 is a flowchart of a modification of the entering order setting process in the parking setting process.

FIG. 15 is a top view showing another example of the parking lot.

FIG. 16 is an explanatory diagram showing another example of the order table.

### DESCRIPTION OF EMBODIMENTS

Next, a relevant technology will be described first only for understanding the following embodiments. As a result of detailed examination by the inventors, it is found tatt, if the exiting vehicle is simply traveled with priority, a non-priority vehicle such as an entering vehicle cannot move for a long time.

One objective of the present disclosure is to avoid a situation where a vehicle cannot move for a long time in a parking-lot when exiting or entering the parking-lot.

According to a first aspect of the present disclosure, a parking assistance device is configured to assist in parking a plurality of autonomous vehicles in a parking lot. Each of the plurality of autonomous vehicles are capable of performing autonomous driving in accordance with a guide route to a target position in the parking lot. The device includes: an order table configured to record an order of setting the guide routes for the plurality of autonomous vehicles; a guide calculation unit configured to calculate the guide routes for the plurality of autonomous vehicles; a re-calculation unit configured to re-calculate, in accordance with the order recorded in the order table, the guide routes for vehicles among the autonomous vehicles for which the guide routes not overlapping with each other cannot be calculated; a guide setting unit configured to: set the guide routes for vehicles among the autonomous vehicles for which the guide routes not overlapping with each other can be calculated; and not set the guide routes for the vehicles for which the guide routes not overlapping with each other cannot be calculated; a route transmission unit configured to transmit the set guide routes to the autonomous vehicles; and an order change unit configured to change the order recorded in the order table in accordance with a circumstance parameter indicative of at least one of a circumstance on the parking lot or a circumstance on each of the autonomous vehicles. The order change unit is configured to adopt, as the circumstance parameter, an unset time indicative of a waiting time during which the guide route for each of the autonomous vehicles cannot be set. The order change unit is configured to advance the order of setting the guide route for an autonomous vehicle when the unset time for the autonomous vehicle is equal to or greater than a predetermined time threshold.

According to a second aspect of the present disclosure, a parking assistance method is performed by a parking assistance device configured to assist in parking a plurality of autonomous vehicles in a parking lot. Each of the plurality of autonomous vehicles is configured to perform autonomous driving in accordance with a guide route to a target position in the parking lot. The method includes: calculating the guide routes for the autonomous vehicles; re-calculating, in an order recorded in an order table, the guide routes for vehicles among the autonomous vehicles for which the guide routes not overlapping with each other cannot be set, the order table being configured to record the order of setting the guide routes for the autonomous vehicles; setting the guide routes for vehicles among the autonomous vehicles for which the guide routes not overlapping with each other can be set and not setting the guide routes for the vehicles for which the guide routes not overlapping with each other cannot be set; transmitting the set guide routes to the autonomous vehicles; and changing the order recorded in the order table in accordance with a circumstance parameter indicative of at least one of a circumstance on the parking lot and a circumstance on each of the autonomous vehicles. An unset time indicative of a waiting time during which the guide route for each of the autonomous vehicles cannot be set is adopted as the circumstance parameter. Changing the order further includes advancing the order of setting the guide route for an autonomous vehicle when the unset time for the autonomous vehicle is equal to or greater than a predetermined time threshold.

According to a third aspect of the present disclosure, a non-transitory, computer readable tangible storage medium stores a parking assistance program executed by a computer of a parking assistance device configured to assist in parking a plurality of autonomous vehicles in a parking lot. Each of the plurality of autonomous vehicles is configured to perform autonomous driving in accordance with a guide route to a target position in the parking lot. The parking assistance program, when executed by the computer, causes the computer to perform: calculating the guide routes for the autonomous vehicles; re-calculating the guide routes for vehicles among the autonomous vehicles for which the guide routes not overlapping with each other cannot be set in accordance with an order recorded in an order table, the order table being configured to record the order of setting the guide routes for the autonomous vehicles; setting the guide routes for vehicles among the autonomous vehicles for which the guide routes not overlapping with each other can be set and not setting the guide routes for the vehicles for which the guide routes not overlapping with each other cannot be set; transmitting the set guide routes to the autonomous vehicles; and changing the order recorded in the order table in accordance with a circumstance parameter indicative of at least one of a circumstance on the parking lot and a circumstance on each of the autonomous vehicles. An unset time indicative of a waiting time during which the guide route for each of the autonomous vehicles cannot be set is adopted as the circumstance parameter. The program further causes the computer to perform advancing the order of setting the guide route for an autonomous vehicle when the unset time for the autonomous vehicle is equal to or greater than a predetermined time threshold.

According to such a configuration, it is possible to change an order of setting a guide route in accordance with a circumstance parameter, and thus it is possible to reduce a likelihood that there is an autonomous vehicle that cannot move for a long time.

Embodiments of the present disclosure will be described below with reference to the drawings.

### 1. EMBODIMENTS

[1-1. Configuration of Parking Assistance System 1]

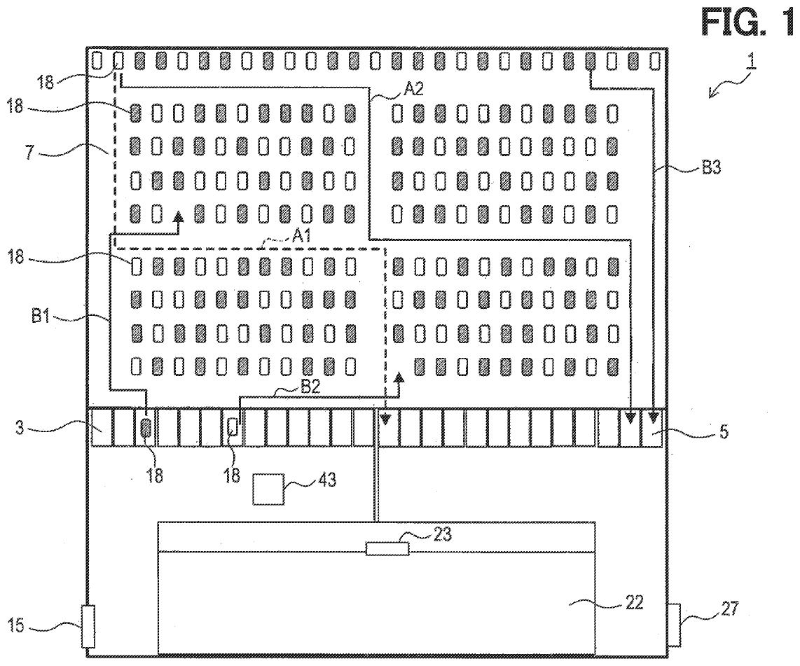

The configuration of a parking assistance system 1 will be described with reference to FIGS. 1 to 3. As shown in FIG. 1, the parking assistance system 1 includes a vehicle entering chamber 3 set in an alighting region where a user gets off, a vehicle exiting chamber 5 set in a boarding region where the user gets on, and a parking area 7. The region including the vehicle entering chamber 3, the vehicle exiting chamber 5, and the parking area 7 will also be referred to as a parking lot below. Multiple sections are provided in each of the vehicle entering chamber 3 and the vehicle exiting chamber 5. The vehicle entering chamber 3 is connected to the outside of the parking assistance system 1 via an inlet 15. An autonomous vehicle 18 can enter into the vehicle entering chamber 3 from the outside through the inlet 15. The autonomous vehicle 18 has an automatic valley parking function.

The autonomous vehicle 18 only needs to be able to execute the automatic valley parking function in the parking lot, and does not need to have a function of performing autonomous driving outside the parking lot. The automatic valley parking function includes a function of traveling from the vehicle entering chamber 3 to a parking position in the parking area 7 and parking by autonomous driving, and a function of traveling from the parking position in the parking area 7 to the vehicle exiting chamber 5.

The automatic valley parking function includes, in particular, a function of repeatedly acquiring the position information of the autonomous vehicle 18 and transmitting the position information to a management device 39 corresponding to the parking assistance device in the present disclosure, and a function of receiving a guide route from the management device 39, controlling the autonomous vehicle 18 in accordance with the guide route, and travelling. The position information of the autonomous vehicle 18 indicates an estimation result of the current location of the autonomous vehicle 18, and includes, for example, coordinate values within the region of the parking lot.

The vehicle entering chamber 3 and the vehicle exiting chamber 5 are adjacent to an inlet 23 of a facility 22 such as a store. The occupant of the autonomous vehicle 18 loaded into the vehicle entering chamber 3 can get off the autonomous vehicle 18 and proceed to the inlet 23 on foot.

The vehicle exiting chamber 5 is connected to the outside of the parking assistance system 1 via an outlet 27. The autonomous vehicle 18 can proceed from the vehicle exiting chamber 5 to the outside of the parking assistance system 1 through the outlet 27. The vehicle exiting chamber 5 is adjacent to the inlet 23. The occupant can proceed to the vehicle exiting chamber 5 from the inlet 23 on foot.

The parking area 7 is a place in which multiple autonomous vehicles 18 can be parked. Multiple sections are provided in the parking area 7. Each section provided in the vehicle entering chamber 3, the vehicle exiting chamber 5, and the parking area 7 is a region in which one autonomous vehicle 18 can be parked. However, the parking area 7 does not need to be provided with the section.

The vehicle entering chamber 3 and the vehicle exiting chamber 5 may change the role of a vehicle compartment depending on the situation. That is, a section used as the vehicle entering chamber 3 at one time may be used as the vehicle exiting chamber 5 at other times. The section used as the vehicle exiting chamber 5 at one time may be used as the vehicle entering chamber 3 at other times. For example, in an initial state, the number of the vehicle entering chambers 3 may be equal to the number of vehicle exiting chambers 5. In a situation in which there are many exiting vehicles, the vehicle entering chamber 3 may be changed to the vehicle exiting chamber 5.

The autonomous vehicle 18 can travel from the vehicle entering chamber 3 to the parking area 7. The autonomous vehicle 18 can travel from the parking area 7 to the vehicle exiting chamber 5.

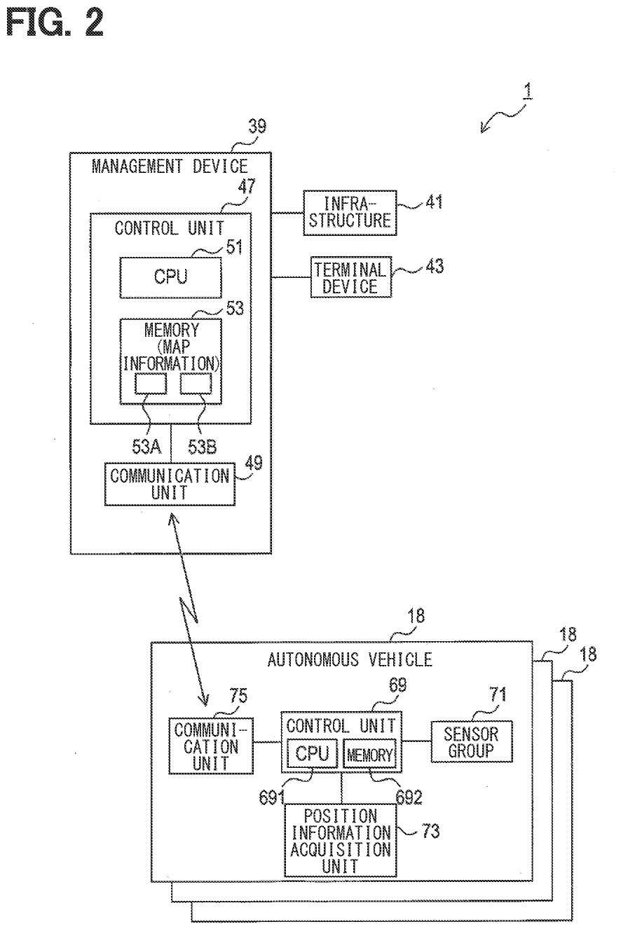

As shown in FIG. 2, the parking assistance system 1 includes the management device 39, an infrastructure 41, and a terminal device 43.

The management device 39 includes a control unit 47 and a communication unit 49. The control unit 47 includes a microcomputer including a CPU 51 and, for example, a semiconductor memory (referred to as a memory 53 below) such as a RAM or a ROM. The management device 39 can manage multiple autonomous vehicles 18.

Each function of the control unit 47 is realized by the CPU 51 executing a program stored in a non-transitory tangible storage medium. The program includes a parking assistance program in the present disclosure. In this example, the memory 53 corresponds to a non-transitory tangible storage medium in which the program is stored. A method corresponding to a program is performed by executing the program. The method corresponding to the program includes a parking assistance method in the present disclosure. The control unit 47 may include one microcomputer or multiple microcomputers.

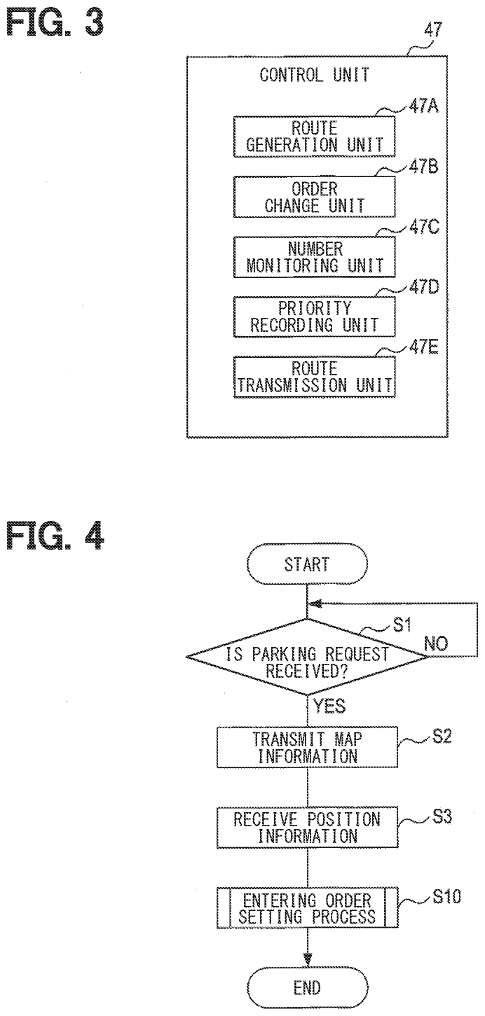

The control unit 47 includes a configuration for transmitting a guide route to a parking position, a parking start instruction, and an exiting start instruction to the autonomous vehicle 18. As shown in FIG. 3, the control unit 47 includes, for example, a route generation unit 47A, an order change unit 47B, a number monitoring unit 47C, and a priority recording unit 47D. The route generation unit 47A corresponds to a guide calculation unit, a guide setting unit, and a re-calculation unit in the present disclosure. The operation of each of the units 47A to 47D constituting the control unit 47 will be described later.

Map information of the parking lot is recorded in the memory 53. Further, the map information includes information indicating the state of the section in the parking area 7. As the state of the section, there are an empty state (referred to as an empty state below) and a state occupied by the autonomous vehicle 18 (referred to as an occupied state below). The communication unit 49 can communicate with the autonomous vehicle 18.

A condition table 53A and an order table 53B are recorded in the memory 53. The condition table 53A and the order table 53B will be described later in detail.

The infrastructure 41 has a function of acquiring information (referred to as in-parking lot information below) representing the internal situation of the parking assistance system 1 and providing the in-parking lot information to the management device 39. The infrastructure 41 includes a camera, a lidar, and the like that captures an image of the inside of the parking lot.

The inside of the parking lot includes a region from the inlet 15 to the vehicle entering chamber 3, the inside of the vehicle entering chamber 3, the parking area 7, the inside of the vehicle exiting chamber 5, and a region from the vehicle exiting chamber 5 to the outlet 27. Further, the inside of the parking lot includes the site and the space of the parking lot, and includes a region from the outside of the parking assistance system 1 to the inlet 15 and a region from the outlet 27 to the outside of the parking assistance system 1.

Examples of the in-parking lot information include information representing the position of an obstacle, information representing the state of a section in the parking area 7, and position information of the autonomous vehicle 18 existing in the parking assistance system 1.

As shown in FIG. 1, the terminal device 43 is installed in the vicinity of the vehicle entering chamber 3. The terminal device 43 outputs a parking request signal in response to an input operation, for example, a parking request, which is the intention of a user to load the autonomous vehicle 18. The intention of entering is also called a entering instruction. The parking request signal is a signal for transporting the autonomous vehicle 18 in the vehicle entering chamber 3 to the parking area 7 and requesting that the vehicle be parked. When the terminal device 43 outputs the signal corresponding to the input operation to the management device 39, the terminal device 43 outputs identification information and the like of the autonomous vehicle 18.

The terminal device 43 outputs an exiting request signal in response to an input operation, for example, an exiting request, which is the intention of a user to unload the autonomous vehicle 18. The intention of exiting is also called an exiting instruction. The exiting request signal is a signal for requesting that the autonomous vehicle 18 parked in the parking area 7 be guided to the vehicle exiting chamber 5.

The terminal device 43 outputs the identification information of the autonomous vehicle 18 in response to an input operation, for example. The identification information is, for example, information such as a number plate for uniquely specifying the autonomous vehicle 18.

As described above, the autonomous vehicle 18 has an automatic valley parking function. As shown in FIG. 2, the autonomous vehicle 18 includes a control unit 69, a sensor group 71, a position information acquisition unit 73, and a communication unit 75.

The control unit 69 includes a microcomputer including a CPU 691 and, for example, a semiconductor memory (referred to as a memory 692 below) such as a RAM or a ROM. The control unit 69 controls each unit of the autonomous vehicle 18. The control unit 69 performs control to realize the function of autonomous driving. The autonomous vehicle 18 acquires the map information and the guide route of the parking lot from the management device 39. When performing autonomous driving, the autonomous vehicle 18 uses the map information and the guide route of the parking lot.

The sensor group 71 acquires peripheral information representing a situation around the autonomous vehicle 18. Examples of the contents of the peripheral information include a position of an obstacle existing around the autonomous vehicle 18. The sensor group 71 includes, for example, a camera, a lidar, and the like. The autonomous vehicle 18 uses the peripheral information when performing autonomous driving.

The position information acquisition unit 73 acquires the position information of the autonomous vehicle 18. The position information acquisition unit 73 is, for example, a position estimation system using a lidar and a map. The autonomous vehicle 18 uses the position information when performing autonomous driving. The communication unit 75 can communicate with the management device 39.

[1-2. Process]

[1-2-1. Parking Setting Process Executed by Management Device 39]

A parking setting process executed by the management device 39 will be described with reference to FIG. 4. The parking setting process is, for example, a process that is started when the power of the management device 39 is turned on and then repeatedly executed. The process of S2 and the subsequent processes in this process are executed for each autonomous vehicle 18 for which a parking request is issued. A process executed by the control unit 47 (particularly the CPU 51) of the management device 39 is also referred to as the process executed by the management device 39 below.

The management device 39 determines whether a parking request signal is received in step (referred to as “5” below) 1 of the parking setting process shown in FIG. 4. This process repeats 51 until the parking request signal is received. When the parking request signal is received, this process proceeds to S2.

When a user such as an occupant of the autonomous vehicle 18 operates the terminal device 43 after getting off, to input a parking request, the terminal device 43 transmits a parking request signal corresponding to this input to the management device 39. At this time, the user inputs vehicle information such as a number plate for specifying a vehicle, user information such as a user ID and a password for specifying the user, and other necessary types of information, to the terminal device 43.

When the terminal device 43 is operated, unique information such as an identification ID for specifying the terminal device 43, vehicle information, and user information is transmitted to the management device 39. After the operation of the parking request, the user can leave the parking lot and head for the destination.

Then, the management device 39 transmits map information of the parking lot to the autonomous vehicle 18 in S2. That is, when an input indicating the start of parking is performed by the user with the terminal device 43, the management device 39 transmits the map information of the parking lot to the autonomous vehicle 18.

The autonomous vehicle 18 that has received the map information is set to return position information and a vehicle condition as described later. Thus, the management device 39 receives the position information transmitted from the autonomous vehicle 18 in S3.

Then, the management device 39 executes a entering order setting process in S10. The entering order setting process is a process of generating a guide route (also referred to as a non-overlapping route below) that does not overlap a guide route set for another autonomous vehicle 18, and moving the autonomous vehicle 18 to a parking position on this guide route. This process includes a process of setting the order when the autonomous vehicle 18 is guided.

“Non-overlapping” means that multiple guide routes do not intersect with and come into contact with each other. The purpose of setting the non-overlapping route is to avoid the contact between multiple autonomous vehicles 18. Therefore, when, even though the multiple guide routes do not come into contact with each other, there is a possibility that the multiple autonomous vehicles 18 come into contact with each other in consideration of the vehicle widths of the multiple autonomous vehicles 18, the management device 39 determines that the multiple guide routes are in contact with each other. When the entering order setting process is completed, the management device 39 ends the parking setting process.

The guide route is set by the parking setting process described above and an exiting setting process described later, respectively, and influences each other. That is, in the parking setting process, another guide route is set to avoid the guide route set in the exiting setting process, and, in the exiting setting process, another guide route is set to avoid the guide route set in the parking setting process.

When the route generation unit 47A in the management device 39 sets a new guide route in the parking setting process and the exiting setting process, the route generation unit 47A sets a guide route to avoid the guide route already set (specifically, including a guide route set by the parking setting process and a guide route set by the exiting setting process). In other words, when setting a new guide route, a procedure in which the route generation unit 47A once creates a guide route from the current location of the autonomous vehicle 18 to a target position, and determines whether the created guide route overlaps other guide routes is not adopted.

[1-2-2. Entering Order Setting Process]

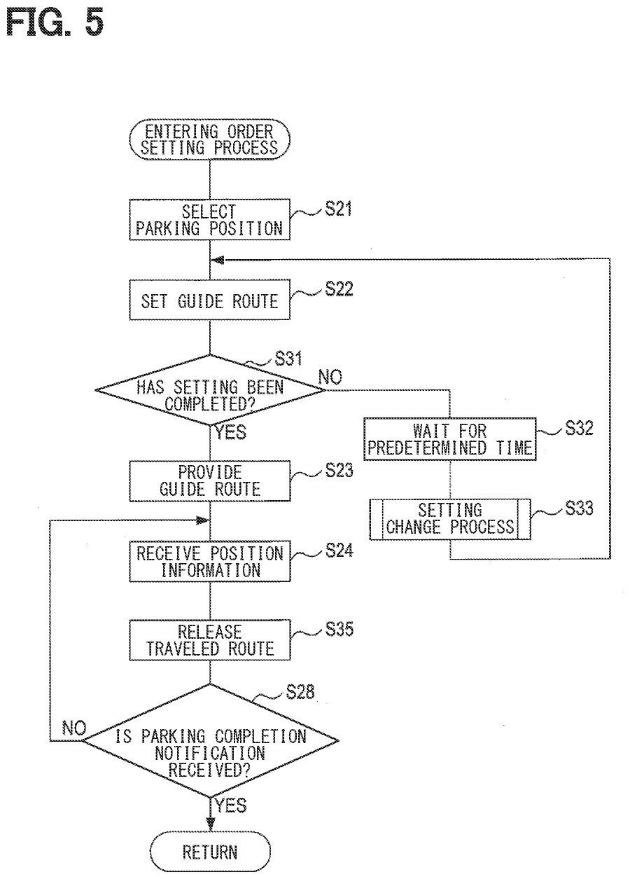

The entering order setting process executed by the management device 39 will be described with reference to FIG. 5. In the entering order setting process, first, in S21, the route generation unit 47A in the management device 39 selects a target position, here, a parking position.

As the parking position, an empty section in the parking area 7 is selected. The route generation unit 47A determines the state of each section as follows, for example. When the autonomous vehicle 18 parks in a certain section, the autonomous vehicle 18 transmits the identification information of the section and parking start information to the management device 39. When the autonomous vehicle 18 leaves the section in which the autonomous vehicle 18 has been parked until now, the autonomous vehicle 18 transmits the identification information of the section and parking end information to the management device 39.

The route generation unit 47A determines the state of each section based on the history of information transmitted from the autonomous vehicle 18. The route generation unit 47A may determine the state of each section based on the information provided by the infrastructure 41. For example, it may be determined whether the autonomous vehicle 18 exists in the section by the camera.

When there is only one empty section, the route generation unit 47A sets that section as the parking position. When there are multiple empty sections, the route generation unit 47A selects one section as the parking position from the multiple empty sections based on a predetermined criterion. As the criteria, for example, a criteria of selecting the section closest to the vehicle entering chamber 3, a criterion of selecting the section closest to the vehicle exiting chamber 5, and a criterion of selecting the section in an area where the empty sections are gathered.

In S22, the route generation unit 47A sets the guide route by using the map information of the parking lot. Here, the route generation unit 47A sets a guide route for self-driving of the autonomous vehicle 18. The guide route is a route from the current location (for example, the vehicle entering chamber 3 in which the autonomous vehicle 18 is parked) of the autonomous vehicle 18 to the parking position selected in S21.

However, when intending to set the guide route of the autonomous vehicle 18, there is a case where a guide route for another autonomous vehicle 18 already exists. In this case, the route generation unit 47A calculates the guide route of the autonomous vehicle 18 to avoid a non-overlapping route, by using the guide route for the other autonomous vehicle 18 as the non-overlapping route. That is, the route generation unit 47A calculates the guide route for each of multiple autonomous vehicles 18 for which the guide route is not set, so that the guide routes do not overlap each other. When the route generation unit 47A can calculate the guide route, the route generation unit 47A sets this guide route as the guide route of the autonomous vehicle 18.

For example, as shown in FIG. 1, when there is an intention to set a guide route A1, and guide routes indicated by B1 and B2 are set previously, it is not possible to set A1. In this case, for example, A2 is set to avoid the guide routes B1 and B2, and guide on the guide route A2 is started. A2 is set so as not to overlap B3.

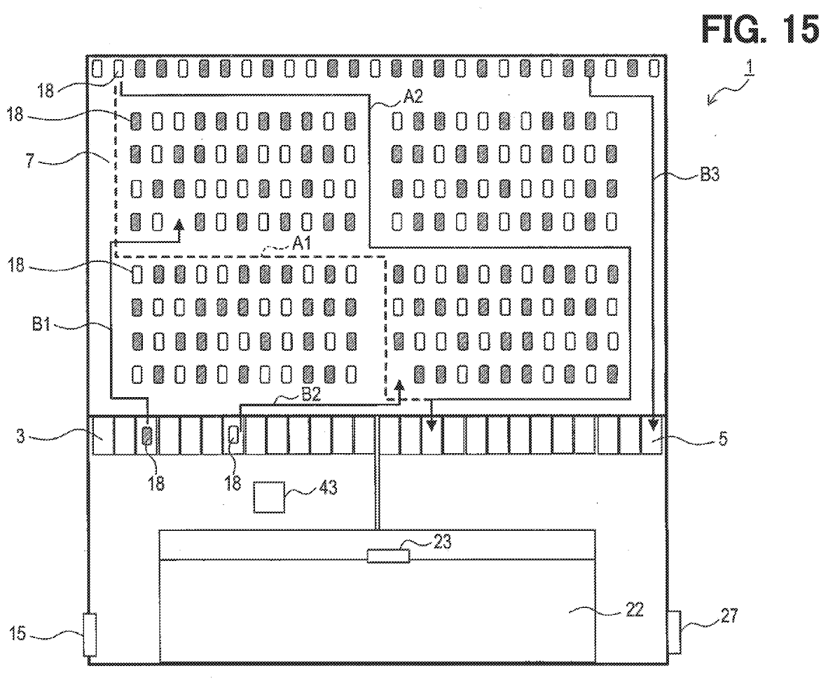

Alternatively, as shown in FIG. 15, the guide route may be set by another route without changing the target position.

When there is an autonomous vehicle 18 for which setting a guide route is not possible, the route generation unit 47A repeatedly executes the process of S22 through the processes of S31 to S33 described later. At this time, when the guide routes for the multiple autonomous vehicles 18 are not set, the guide routes are set for the multiple autonomous vehicles 18 in an order determined by the priority set in the order table 53B described later.

The route generation unit 47A refers to the order table 53B in S22, and specifies the autonomous vehicle 18 having the highest priority among the multiple autonomous vehicles 18 for which the guide route is not set. Then, the route generation unit 47A tries the guide route of the specified autonomous vehicle 18. When the guide route of the autonomous vehicle 18 is set, the autonomous vehicle 18 having the highest priority is specified among the autonomous vehicles 18 for which the guide route is not set. Then, the route generation unit 47A tries to set the guide route of the specified autonomous vehicle 18.

The number monitoring unit 47C monitors an order change count. When there is an autonomous vehicle 18 for which setting a guide route is not possible, the priority recording unit 47D in the management device 39 records, in the order table 53B, setting information in which information for specifying the autonomous vehicle 18 and the priority are associated with each other. The management device 39 updates the description contents such as a waiting time in the order table 53B.

The management device 39 proceeds to S31 after the process of S22. The route generation unit 47A may not be able to set the guide route when intending to avoid the non-overlapping route. In this case, the management device 39 proceeds to S31 without setting the guide route in S22.

The map information in the parking lot, which is stored in the memory 53, is associated with whether a route is usable as a guide route, for each passage. When there are multiple lanes in a certain passage, whether the lane can be used as the guide route may be associated for each lane.

Then, a passage set as a non-overlapping route or a passage in which the abnormality has occurred is set to be unusable. When the abnormality is resolved, or the autonomous vehicle 18 finishes traveling on the non-overlapping route, and the passage is opened, this passage is set to be usable.

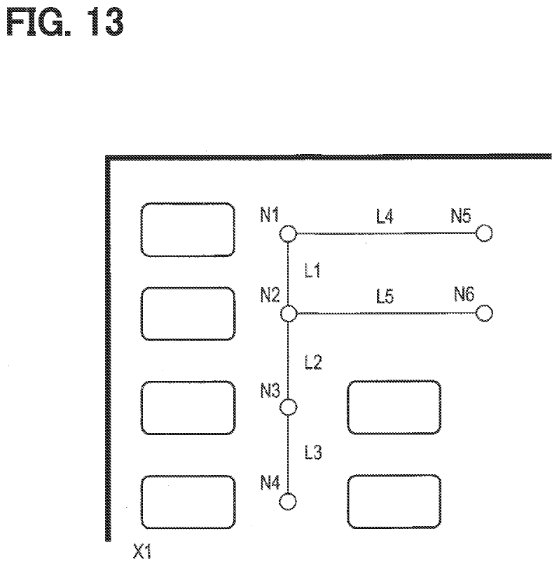

For example, in the map information in the parking lot, the passage is represented by a combination of a node and a link. FIG. 13 illustrates links and nodes for a portion of the parking area 7 in FIG. 1. FIG. 13 illustrates nodes N1, N2, N3, N4, N5, and N6, and links L1, L2, L3, L4, and L5. The link corresponds to a passage between the nodes. Although not shown, a route from the parking section to the node is also stored as a route through which a vehicle can travel.

The memory 53 stores whether a guide route is already set for each link. Further, in order to restrict contacts between the guide routes of the multiple autonomous vehicles 18, whether the guide route for each node is already set may be stored. For example, it is assumed that the autonomous vehicle 18 is parked in a parking section X and heads for the vehicle exiting chamber 5. In this case, it is assumed that a guide route passing from the parking section X1 through the nodes N4, N3, N2, and N6 is created.

In this case, the nodes N4, N3, N2, and N6, and the links L3, L2, and L5 are set to be unusable. Further, it is assumed that the autonomous vehicle 18 starts moving and reaches the node N2. In this case, as will be described later, the traveled route is released, and the nodes N4 and N3, and the links L2 and L3 are changed from the unusable state to the usable state.

Then, in S31, the management device 39 determines whether setting the guide route for the autonomous vehicle 18 is possible. When setting the guide route is not possible, the route generation unit 47A waits for a predetermined time set in advance in S32. Then, the route generation unit 47A executes a setting change process in S33. The setting change process will be described later. Then, this process returns to S22 and tries to calculate and set the guide route again. Here, the guide route may be reset immediately, but, in order to reduce the processing load of the management device 39, in the present embodiment, the guide route is reset after waiting for a predetermined time.

When setting the guide route is determined to be possible in S31, a route transmission unit in the management device 39 transmits information (referred to as guide route information below) representing the guide route set in S22, by using the communication unit 49 in S23. As will be described later, the autonomous vehicle 18 receives the guide route information and starts autonomous driving in accordance with the guide route.

Then, the management device 39 acquires the position information of the autonomous vehicle 18 in S24. That is, the management device 39 repeatedly receives the position information of the multiple autonomous vehicles 18 until a parking completion notification is received.

Then, in S35, the management device 39 releases the traveled route. That is, the management device 39 specifies a portion in which the autonomous vehicle 18 has already traveled in the passage set as the guide route in the parking lot, from the current location of the autonomous vehicle 18, and excludes the specified portion from the guide route. More specifically, the management device 39 changes the setting of the portion in which the autonomous vehicle 18 has already traveled in the passage set to be unusable in the map information, to be usable. As a result, the portion in which the autonomous vehicle 18 has already traveled can be used as a guide route for another autonomous vehicle 18.

Then, in S28, the management device 39 determines whether the communication unit 49 has received the parking completion notification. The parking completion notification is a notification transmitted by the autonomous vehicle 18 when the autonomous vehicle 18 is parked at the target position indicating the end point of the guide route, in this case, the parking position. When the parking completion notification is received, this process is ended. When the parking completion notification is not received, this process returns to S24.

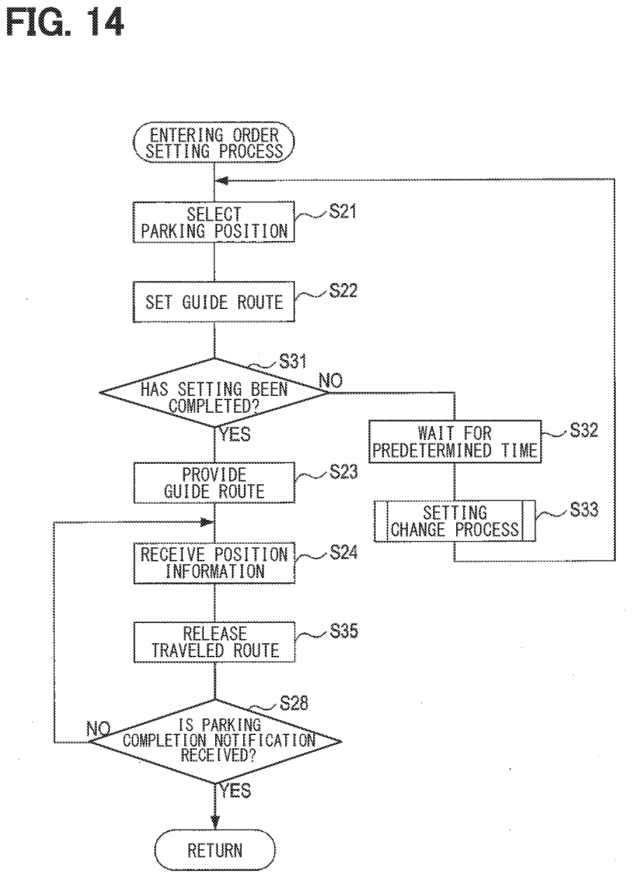

FIG. 14 is a modification of a flowchart of the entering order setting process in the parking setting process. When setting the guide route is not possible in S31, the route generation unit 47A may return to S21 after executing the setting change process in S33 following S32. In S32, because the entering order setting process waits for a predetermined time, the traveled guide route may be released by another autonomous vehicle 18 traveling within the predetermined time. Thus, the route generation unit 47A selects the parking position again in S21, and thus a possibility that setting guide routes that do not overlap is possible is increased.

[1-2-3. Setting Change Process]

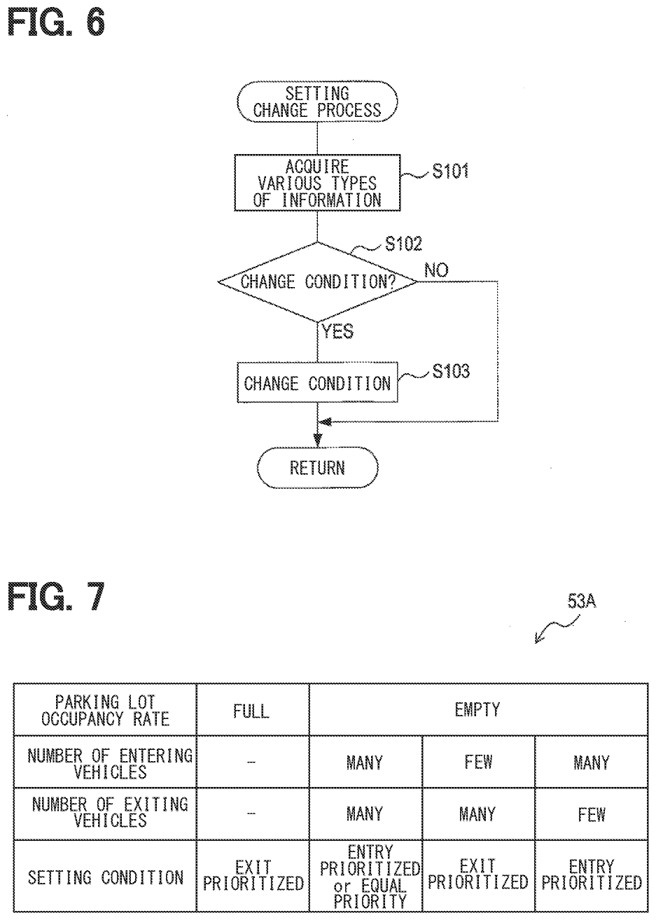

The setting change process executed by the management device 39 will be described with reference to the flowchart of FIG. 6.

First, in S101, the management device 39 acquires various types of information. The various types of information include in-parking lot information, vehicle information, user information, the current time, the condition table 53A, and the order table 53B.

Then, in S102, the management device 39 determines whether to change the priority condition. The priority conditions will be described with reference to FIG. 7.

As shown in FIG. 7, in the condition table 53A, setting conditions corresponding to the circumstance parameter in the present disclosure are associated in accordance with the occupancy rate of a parking lot, the number of vehicles to enter, and the number of vehicles to exit. The setting condition may be interpreted as a so-called operating mode. A program may be prepared for each operating mode. The circumstance parameter is a parameter representing at least one of the circumstance on the parking lot side and the circumstance on the autonomous vehicle 18 side. As the circumstance parameter in the condition table 53A, parameters related to the circumstance on the parking lot side are exemplified. The parameter related to the circumstance on the parking lot side is also called a parameter related to the parking lot side.

In the condition table 53A, a state where the occupancy rate of the parking lot, in other words, the ratio of parking sections filled with vehicles among multiple parking sections, is 100% or close to 100% is described as “Full”, and other states are described as “Empty”. When the occupancy rate of the parking lot is “full”, “exit prioritized” is selected as the setting condition. In other words, when the occupancy rate of the parking lot is equal to or greater than a reference value set in advance, “exit prioritized” is selected as the setting condition. When the occupancy rate of the parking lot is smaller than the reference value set in advance, “entry prioritized” is selected as the setting condition.

The exiting prioritized means that, when a guide route is set for a vehicle requesting to enter and a vehicle requesting to exit, the guide route is set with priority given to the vehicle requesting to exit. On the other hand, the entry prioritized means that, when a guide route is set for a vehicle requesting to enter and a vehicle requesting to exit, the guide route is set with priority given to the vehicle requesting to enter.

In the condition table 53A, when the number of vehicles to enter, which is the number of vehicles requesting to enter, and the number of vehicles to exit, which is the number of vehicles requesting to exit, are equal to or greater than a threshold set in advance, “Many” is descried. In the condition table 53A, when the number of vehicles to enter and the number of vehicles to exit are smaller than the threshold, “Few” is described. When the occupancy rate of the parking lot is “empty”, the management device 39 determines the setting conditions for the autonomous vehicle 18 for which the guide route is not set, in accordance with the number of vehicles to enter and the number of vehicles to exit.

The number of vehicles to enter is determined, for example, based on the number of parking requests input by operating the terminal device 43. Alternatively, the number of vehicles to enter is determined based on the degree of congestion in the vehicle entering chamber 3, which is detected by the infrastructure 41, and the number of vehicles traveling from the inlet 15 to the vehicle entering chamber 3. The number of vehicles to exit is determined, for example, based on the number of exiting requests input by operating the terminal device 43.

That is, when the number of vehicles to enter and the number of vehicles to exit are “many”, the management device 39 selects “entry prioritized” or “equal” as the setting condition. The entering prioritized means that, when a guide route is set for a vehicle requesting to enter and a vehicle requesting to exit, the guide route is set with priority given to the vehicle requesting to enter. Being equal means that a guide route is set for a vehicle requesting to enter and a vehicle requesting to exit without giving any priority.

When the tendency of the number of vehicles to enter and the number of vehicles to exit is known in advance, “exit prioritized”, “entry prioritized”, or “equal” may be selected depending on the time period. It is preferable that “exit prioritized” is selected in the time period when there are many vehicles to exit, and “entry prioritized” is selected in the time period when there are many vehicles to enter. Alternatively, “exit prioritized”, “entry prioritized”, or “equal” may be selected in accordance with the time period and the day of the week. The management device 39 selects “exit prioritized”, “entry prioritized”, or “equal” based on the information registered in advance in the memory 53, the current time, and the day of the week.

In S102, when any of the occupancy rate of the parking lot, the number of vehicles to enter, and the number of vehicles to exit is changed and it is necessary to change the setting condition, the management device 39 determines to change the priority condition. Then, the order change unit 47B changes the priority in S103, which will be described later, so that the priority of the autonomous vehicle 18 to be prioritized becomes higher.

The management device 39 changes the priority condition in accordance with the parameter related to the circumstance on the autonomous vehicle 18 side. The parameter related to the circumstances on the autonomous vehicle 18 side is also referred to as a parameter related to the autonomous vehicle 18. Specifically, the management device 39 adopts an unset time, a distance between the parking position and the getting-in/getting-out area, and the order change count, as the parameters related to the circumstance on the autonomous vehicle 18 side.

The unset time indicates a waiting time during which the guide route for an autonomous vehicle 18 cannot be set. The unset time includes an entering standby time indicating the waiting time during which the guide route for an autonomous vehicle 18 requesting to enter cannot be set and an exiting standby time indicating a waiting time during which a guide route for an autonomous vehicle 18 requesting to exit cannot be set. However, as the unset time, either one of the entering standby time and the exiting standby time may be adopted. Alternatively, as the unset time, the entering standby time and the exiting standby time may be managed separately.

The distance between the parking position and the getting-in/getting-out area represents a distance between the parking position in the parking area 7 assigned to the autonomous vehicle 18 and the getting-in/getting-out area where the user gets on and off. The order change count represents the number of times that the guide route of the autonomous vehicle 18 that has transmitted the parking request or the exiting request later is set before the guide route of the autonomous vehicle 18 that has transmitted the parking request or the exiting request previously. To describe the order change count more simply, the order change count represents the number of times that the autonomous vehicle 18 that has transmitted the request later has skipped the order of generating (in other words, the order of setting) the guide route.

In the order table 53B, for the vehicle ID for specifying the autonomous vehicle 18, each of items of entering-exiting, distance, waiting time, order change count, route setting, priority before change, and priority after change are associated. “In/Out” is a classification of whether the autonomous vehicle 18 requests to enter or unloaded. When the autonomous vehicle 18 is requesting to enter, “In” is written. When the autonomous vehicle 18 requests to exit, “Out” is written.

“Distance” corresponds to the distance between the parking position and the getting-in/getting-out area. Here, for example, “distance” is divided into three stages in accordance with a straight line distance, and one of 1, 2, and 3 is written in ascending order of distance. When the distance between the parking position and the getting-in/getting-out area is expected to be equal to or greater than a predetermined distance (or predetermined traveling time) set in advance, the management device 39 determines to change the priority condition. Then, the order change unit 47B advances the order of setting the guide route as the distance becomes longer, in S103, which will be described later.

“Waiting time” corresponds to the unset time. When the unset time is equal to or greater than a time threshold (for example, about 3 minutes) set in advance, the management device 39 determines to change the priority condition. The order change unit 47B advances the order of setting the guide route for the autonomous vehicle 18 at S103 which will be described later.

The unset time of the autonomous vehicle 18 requesting to enter is, for example, a time between a timing the intention of entering is input and a timing the guide route is set. The unset time of the autonomous vehicle 18 requesting to exit is, for example, a time between a timing the intention of exiting is input and a timing the guide route is set.

Regarding the “order change count”, when the order change count is equal to or greater than a count threshold set in advance, the management device 39 determines to change the priority condition, and the order change unit 47B advances the order of setting the guide route of the autonomous vehicle 18 in S103 which will be described later.

“Route setting” represents whether the guide route is set. “a” indicates the guide route can be set. “x” indicates the guide route cannot be set.

“Priority before change” and “priority after change” indicate the priority before and after the condition change, or the priority. The smaller the value, the higher the priority for setting the guide route.

When the management device 39 determines not to change the priority condition in S102, the management device 39 ends the setting change process in FIG. 6. On the other hand, when the management device 39 determines to change the priority condition in S102, the management device 39 proceeds to S103 and changes the priority condition.

For example, the management device 39 determines how many requirements to change the priority are satisfied for the autonomous vehicle 18 requesting to enter, for which the guide route is not set, and for the autonomous vehicle 18 requesting to exit, for which the guide route is not set. Then, the management device 39 stores results. For all the autonomous vehicles 18, after the number of requirements for which the priority is to be changed is calculated, the priority is increased in descending order of the number corresponding to the requirements for which the priority is to be changed. That is, the guide route is set with higher priority for the autonomous vehicle 18 having a large number corresponding to the requirement for changing the priority.

The guide route is set by the parking setting process and the exiting setting process, respectively, and influences each other. Thus, using the order table 53B, the management device 39 ranks the autonomous vehicle 18 for which the guide route is to be calculated by the parking setting process and the autonomous vehicle 18 for which the guide route is to be calculated by the exiting setting process.

An example of a priority determination method when exiting is prioritized is as follows. A first condition is that the classification of “entering-exiting” is “exiting”. A second condition is that “distance” is equal to or greater than a predetermined distance. A third condition is that “waiting time” is equal to or greater than the time threshold. A fourth condition is that “order change count” is equal to or greater than the count threshold. The predetermined distance, the time threshold, and the count threshold may be predetermined values, or may be updated during the operation of the parking assistance system 1.

An example of the priority determination method when entering is prioritized is as follows. Condition 1 is that the classification of “entering-exiting” is “entering”. Condition 2 is that “distance” is equal to or greater than a predetermined distance. Condition 3 is that “waiting time” is equal to or greater than the time threshold. Condition 4 is that “order change count” is equal to or greater than the count threshold.

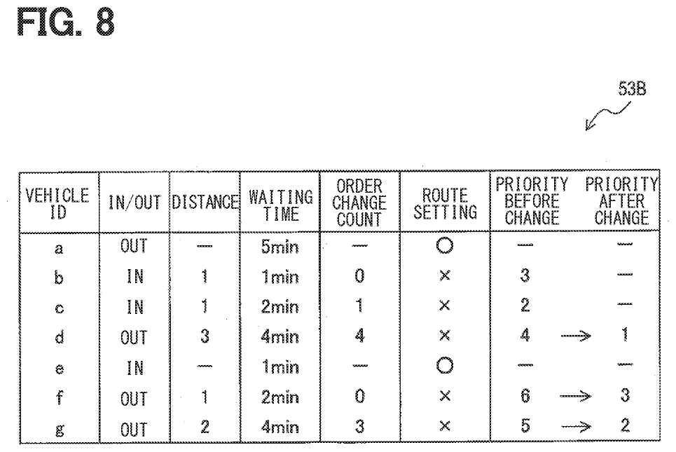

For example, when the parking lot occupancy rate is “full” and “exit prioritized” is set, the change of priority will be described with reference to the example shown in FIG. 8. The guide route has already been set for the autonomous vehicles 18 having the vehicle IDs “a” and “e”. The autonomous vehicles 18 having the vehicle IDs “b” and “c” do not correspond to the requirement for changing the priority condition. Since the parking lot occupancy rate is in the “full” state, it is necessary to restrict the entry into the parking area 7 even though there is a vehicle requesting to enter. Thus, a high priority is not given to the autonomous vehicles 18 having the vehicle IDs “a”, “b”, “c”, and “e”, in other words, the change of advancing the priority is not performed.

On the other hand, in the autonomous vehicle 18 having the vehicle ID “d”, the classification of “entering-exiting” is “exiting”, “distance” is “3”, which is equal to or greater than the predetermined distance, “waiting time” is “4 min”, which is equal to or greater than the time threshold, and “order change count” is “4”, which is equal to or greater than the count threshold. That is, the autonomous vehicle 18 having the vehicle ID “d” corresponds to the four requirements to change the priority.

In the autonomous vehicle 18 having the vehicle ID “g”, the classification of “entering-exiting” is “exiting”, “waiting time” is “4 min”, which is equal to or greater than the time threshold, and “order change count” is “3”, which is equal to or greater than the count threshold. That is, the autonomous vehicle 18 having the vehicle ID “g” corresponds to the three requirements to change the priority.

In the autonomous vehicle 18 having the vehicle ID “f”, the classification of “entering-exiting” is “exiting” That is, the autonomous vehicle 18 having the vehicle ID “f” corresponds to one requirement to change the priority.

Therefore, here, the priority is set higher in descending order of the number corresponding to requirements to change the priority, and the priority for which the guide route is set in the order of the vehicle IDs “d”, “g”, and “f” is set higher. Then, the priority is lowered for other vehicle IDs “a”, “b”, “c”, and “e”.

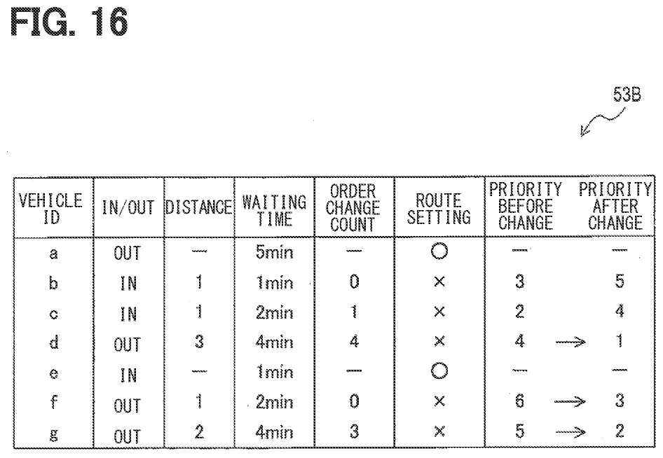

The change of priority will be described with reference to FIG. 16. For example, a change of priority when the parking lot occupancy rate is “empty”, the number of vehicles to enter is “few”, the number of vehicles to exit is “many”, and “exit prioritized” is set will be described with reference to FIG. 16.

Since the guide route has already been set for the autonomous vehicles 18 having the vehicle IDs “a” and “e”, the change of the priority is not considered.

The management device 39 determines how many requirements to change the priority are satisfied for each of the autonomous vehicles 18 having the vehicle IDs “b”, “c”, “d”, “f”, and “g”.

In the autonomous vehicle 18 having the vehicle ID “b”, the classification of “entering-exiting” is “entering”, “distance” is “1”, which is smaller than the predetermined distance, “waiting time” is “1 min”, which is smaller than the time threshold, and “order change count” is “0”, which is smaller than the count threshold. That is, none of the requirements to change the priority correspond.

In the autonomous vehicle 18 having the vehicle ID “c”, the classification of “entering-exiting” is “entering”, “distance” is “1”, which is smaller than the predetermined distance, “waiting time” is “2 min”, which is smaller than the time threshold, and “order change count” is “1”, which is smaller than the count threshold. That is, none of the requirements to change the priority correspond.

The autonomous vehicles 18 having the vehicle IDs “d”, “f”, and “g” are similar to those in FIG. 8.

Thus, the autonomous vehicle 18 having the vehicle ID “d” satisfies the four requirements, and the autonomous vehicle 18 having the vehicle ID “g” satisfies the three requirements. The autonomous vehicle 18 having the vehicle ID “f” satisfies one requirement, and the autonomous vehicles 18 having the vehicle IDs “c” and “d” do not satisfy any of the requirements. Therefore, regarding the priority after the change, the autonomous vehicles 18 having the vehicle IDs “d”, “g”, “f”, “c”, and “b” in descending order are obtained. When the number of requirements to change the priority satisfied by the autonomous vehicle 18 is equal, for example, the one with the earlier time of receiving the input operation of the entering intention or the exiting intention is given priority.

Then, the management device 39 ends the setting change process in FIG. 6. Multiple thresholds for each of “distance”, “waiting time”, and “order change count” may be set.

For example, a first time threshold and a second time threshold may be set for “waiting time”. The second time threshold is set longer than the first time threshold. In this case, when “waiting time” of the autonomous vehicle 18 becomes equal to or greater than the first time threshold, it is determined that the requirement to change the priority is satisfied. Further, when “waiting time” of the autonomous vehicle 18 becomes equal to or greater than the second time threshold, the priority after the change is maximized regardless of whether the other requirements to change the priority are satisfied. With such a configuration, it is possible to more reliably limit the occurrence of the autonomous vehicle 18 for which the guide route is not set.

Further, as the circumstance parameter in the present disclosure, the parameter representing the circumstance on the autonomous vehicle 18 side may be adopted, and the parameter representing the circumstance on the parking lot side may not be adopted. The management device 39 adopts at least one of the unset time, the distance between the parking position and the getting-in/getting-out area, and the order change count, as the parameters related to the circumstance on the autonomous vehicle 18 side.

In this case, the management device 39 calculates the guide route of the corresponding autonomous vehicle 18 in the order of receiving the input operation that is the intention of entering or exiting. When there are multiple autonomous vehicles 18 for which calculation of a non-overlapping guide route is not possible, the priority of the autonomous vehicle 18 for which the guide route is calculated is determined based on the parameters related to the circumstances on the autonomous vehicle 18 side.

[1-2-4. Automatic Parking Process Executed by Autonomous Vehicle 18]

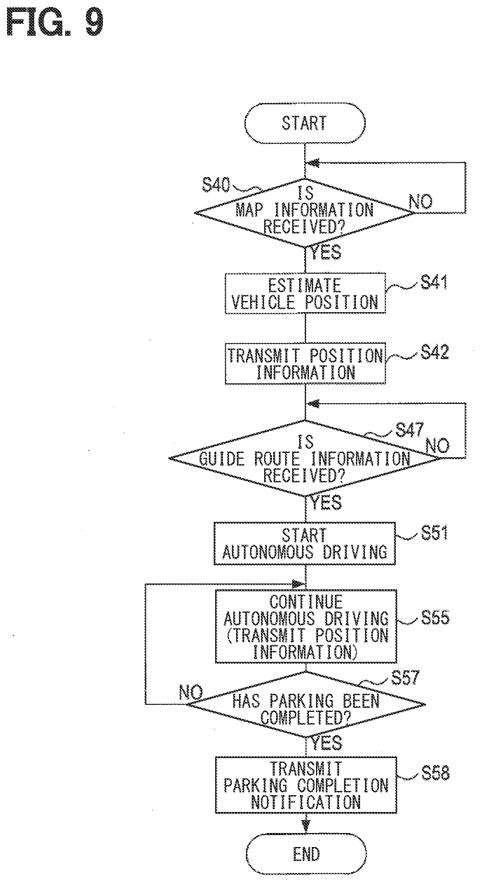

An automatic parking process executed by the autonomous vehicle 18 will be described with reference to FIG. 9. The automatic parking process is a process in which the autonomous vehicle 18 performs autonomous driving from the vehicle entering chamber 3 to the parking position in accordance with the parking setting process executed by the management device 39. The process executed by the autonomous vehicle 18 (particularly the CPU 691) is referred to as being executed by the autonomous vehicle 18 below.

In S40, the autonomous vehicle 18 determines whether the communication unit 75 has received the map information of the parking lot. When the map information has not been received, the process returns to S40.

When the map information is received, the process proceeds to S41, and the autonomous vehicle 18 estimates the current location of the autonomous vehicle 18. Then, in S42, the estimation result of the current location is transmitted to the management device 39 as the position information of the autonomous vehicle 18.

Then, in S47, the autonomous vehicle 18 determines whether the guide route information has been received. When the guide route information is not received in S47, the process returns to S47.

When the guide route information is received, the autonomous vehicle 18 starts the autonomous driving of the autonomous vehicle 18 in S51. When performing autonomous driving, the autonomous vehicle 18 travels in accordance with the guide route included in the guide route information.

Then, the autonomous vehicle 18 continues the autonomous driving of the autonomous vehicle 18 in S55. At this time, the autonomous vehicle 18 repeatedly transmits the position information of the autonomous vehicle 18 to the management device 39 until it is determined in S57, which will be described later, that parking has been completed. The transmitted position information is received by the management device 39.

Then, in S57, the autonomous vehicle 18 determines whether parking has been completed. The completion of the parking means that the autonomous vehicle 18 has arrived at the parking position set in the management device 39. When parking is not completed, the process returns to S55.

When parking has been completed, the process proceeds to S58, and the autonomous vehicle 18 transmits a parking completion notification by using the communication unit 75 and ends this process. The management device 39 receives the transmitted parking completion notification.

[1-2-5. Exiting Setting Process Executed by Management Device 39]

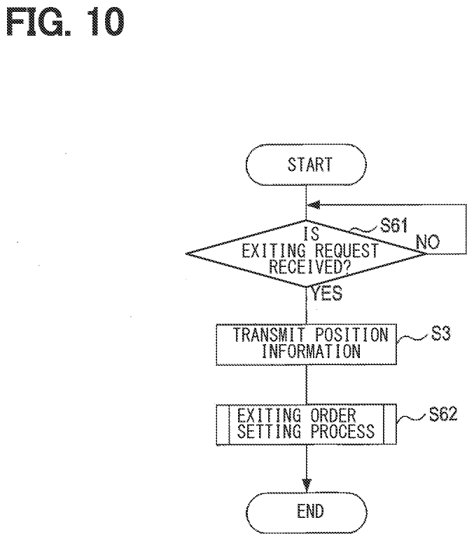

The exiting setting process executed by the management device 39 will be described with reference to FIG. 10. The exiting setting process is a process of moving the autonomous vehicle 18 from the parking position to the vehicle exiting chamber 5 by the self-driving of the autonomous vehicle 18. The process of S3 and the subsequent processes in this process are executed for each autonomous vehicle 18 for which an exiting request is issued.

The exiting setting process is a process repeatedly executed by the control unit 47 in the management device 39, for example, in parallel with other processes. In the exiting setting process, first, in S61, the route generation unit 47A determines whether the exiting request signal has been received. When the user operates the terminal device 43 to input the exiting request, the terminal device 43 transmits an exiting request signal to the management device 39.

When there is no exiting request signal, this process repeats S61. When there is the exiting request signal, the process proceeds to S3 and the position information transmitted from the autonomous vehicle 18 is received. Then, this process proceeds to S62, and the exiting order setting process is executed. The exiting order setting process is a process of generating a guide route that does not overlap the guide route of another autonomous vehicle 18 and moving the autonomous vehicle 18 to the vehicle exiting chamber 5 on this guide route. This process includes a process of setting the order when the autonomous vehicle 18 is guided. When the exiting order setting process is ended, the management device 39 ends the exiting setting process.

[1-2-6. Exiting Order Setting Process]

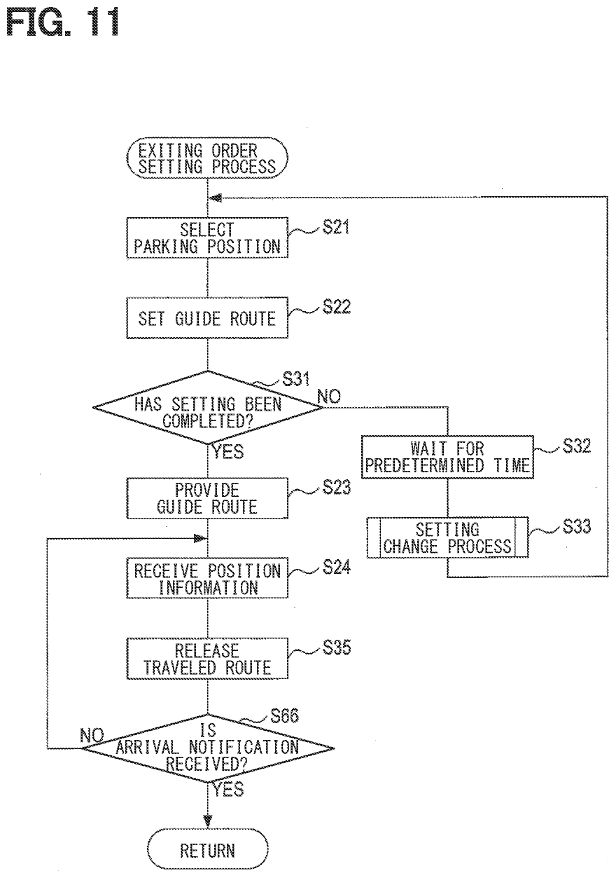

The exiting order setting process executed by the management device 39 will be described with reference to FIG. 11. In the exiting order setting process, as shown in FIGS. 11, S21 to S24, S31 to S33, and S35 of the above-described entering order setting process (FIG. 5) are executed. However, in S21, the route generation unit 47A selects one section in the vehicle exiting chamber 5 as the target position.

Subsequent to S35, in S66, the autonomous vehicle 18 determines whether the exiting completion notification (also referred to as an arrival notification) has been received. The exiting completion notification is a notification transmitted from the autonomous vehicle 18 when the autonomous vehicle 18 has arrived at the vehicle exiting chamber 5 which is a target position by self-driving.

When the route generation unit 47A has not received the exiting completion notification, the process returns to the process of S24. When the route generation unit 47A has received the exiting completion notification, the route generation unit 47A ends this process.

[1-2-7. Automatic Exiting Process Executed by Autonomous Vehicle 18]

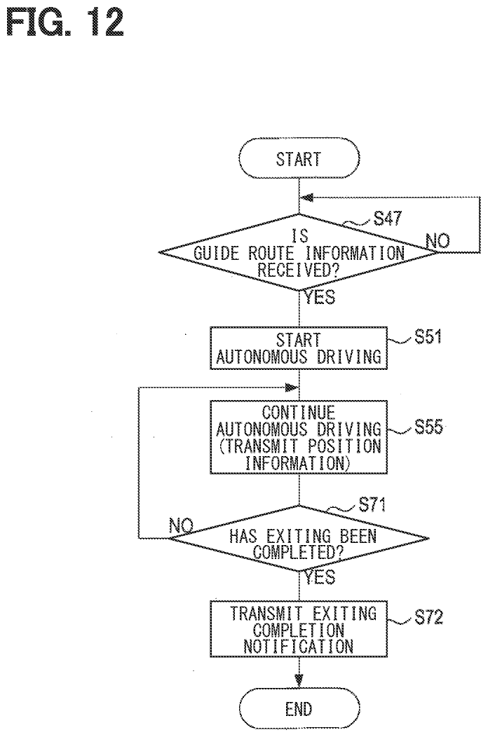

An automatic exiting process executed by the autonomous vehicle 18 will be described with reference to FIG. 12. The automatic exiting process is a process of causing the autonomous vehicle 18 to travel from the parking position to the vehicle exiting chamber 5 in accordance with the exiting setting process executed by the management device 39.

In the automatic exiting process, as shown in FIG. 12, the processes of S47, S51, and S55 in the above-described automatic exiting process are executed. After S55, in S71, the autonomous vehicle 18 determines whether the exiting has been completed. When it is detected that the autonomous vehicle 18 has arrived at the vehicle exiting chamber 5, which is the target position, the autonomous vehicle 18 determines that the exiting has been completed.

When the exiting is not completed, the process returns to S55. When the exiting has been completed, in S72, the autonomous vehicle 18 transmits the exiting completion notification to the management device 39, and ends the automatic exiting process.

[1-3. Effects]

According to the first embodiment described in detail above, the following effects are exhibited.

(1a) One aspect of the present disclosure is a management device 39 configured to assist in parking a vehicle. In the parking lot, multiple vehicles configured to enable autonomous driving in accordance with a guide route set by the management device 39 are assumed to be multiple autonomous vehicles 18.

The management device 39 includes a route generation unit 47A and an order change unit 47B. The route generation unit 47A is configured to respectively set the guide routes for the multiple autonomous vehicles 18 so as not to overlap each other.

The route generation unit 47A is configured to, when setting the guide route is not possible and the guide routes for the plurality of autonomous vehicles 18 are not set, set the guide route again for the multiple autonomous vehicles 18 in accordance with an order set in advance.

The order change unit 47B is configured to change the order in accordance with a circumstance parameter representing at least one of the circumstance on the parking lot side and the circumstance on the autonomous vehicle 18 side.

According to such a configuration, it is possible to change an order of setting a guide route in accordance with a circumstance parameter, and thus it is possible to reduce a likelihood that there is an autonomous vehicle 18 that cannot move for a long time.

(1b) In one aspect of the present disclosure, as the circumstance parameter, an unset time indicative of a waiting time during which the guide route for an autonomous vehicle 18 cannot be set is adopted. When the unset time for an autonomous vehicle is equal to or greater than a time threshold set in advance, the order change unit 47B advances the order of setting the guide route for the autonomous vehicle 18.

According to such a configuration, when the unset time is equal to or greater than the time threshold, it is possible to easily generate a guide route of the autonomous vehicle 18. Thus, it is possible to reduce a likelihood that there is the autonomous vehicle 18 that cannot move for a long time.

(1c) In one aspect of the present disclosure, the order change unit 47B is configured to set a second time threshold having a value greater than a first time threshold, as the circumstance parameter, and, when the unset time for an autonomous vehicle is equal to or greater than the second time threshold, set the order of setting the guide route for the autonomous vehicle 18 first.

According to such a configuration, it is possible to set the guide route of the autonomous vehicle 18 in which the unset time is equal to or greater than the second time threshold, with the highest priority.

(1d) In one aspect of the present disclosure, as the circumstance parameter, the exiting standby time representing the time during which generation of the guide route for the autonomous vehicle 18 requesting to exit is not possible is adopted. When the time during which generation of the guide route is not possible becomes equal to or greater than the time threshold set in advance, the order change unit 47B advances the order of setting the guide route of the autonomous vehicle 18.

According to such a configuration, when the exiting standby time is equal to or greater than the time threshold set in advance, it is possible to easily generate a guide route of the autonomous vehicle 18. Thus, it is possible to reduce a likelihood that there is the autonomous vehicle 18 that cannot move for a long time.

(1e) In one aspect of the present disclosure, identification information of whether the autonomous vehicle 18 is a vehicle requesting to enter or a vehicle requesting to exit is recorded in the order table 53B. Then, the number of the autonomous vehicles 18 requesting to exit and the number of the autonomous vehicles 18 requesting to enter are adopted as the circumstance parameters. The order change unit 47B advances the order of setting the guide route of the autonomous vehicle 18 on the side with a large number of vehicles.

According to such a configuration, it is possible to set the order of setting the guide route with priority given to the congested one of the entering and the exiting.

(1f) In one aspect of the present disclosure, the order change unit 47B adopts, as the circumstance parameter, the number of autonomous vehicles 18 requesting to exit and the number of autonomous vehicles 18 requesting to enter. Then, when the number of the autonomous vehicles 18 requesting to exit is greater than the number of the autonomous vehicles 18 requesting to enter, the order change unit 47B advances the order of setting the guide route of the autonomous vehicle 18 requesting to exit. When the number of the autonomous vehicles 18 requesting to enter is greater than the number of the autonomous vehicles 18 requesting to exit, the order change unit 47B advances the order of setting the guide route of the autonomous vehicle 18 requesting to enter.

According to such a configuration, it is possible to set the order of setting the guide route with priority given to the congested one of the entering and the exiting.

(1g) In one aspect of the present disclosure, the order change unit 47B adopts the occupancy rate of the parking lot as the circumstance parameter. Then, when the occupancy rate is equal to or greater than a reference value set in advance, the order change unit 47B advances the order of setting the guide route of the autonomous vehicle requesting to exit. When the occupancy rate of the parking lot is smaller than the reference value, the order change unit 47B advances the order of setting the guide route of the autonomous vehicle requesting to enter.

According to such a configuration, when the occupancy rate of the parking lot is high, it is possible to set the order of setting the guide route so as to reduce the number of vehicles in the parking lot. Thus, it is possible to limit an occurrence of a situation in which moving of the autonomous vehicle 18 is hindered by another vehicle in the parking lot. Therefore, the management device 39 can smoothly move the vehicle in the parking lot.

(1h) In one aspect of the present disclosure, the parking position in the parking area 7 assigned to the autonomous vehicle 18 is recorded in the order table 53B. Then, as the circumstance parameter, the distance between the parking position of the parking area 7 assigned to the autonomous vehicle 18 and the getting-in/getting-out area where the user gets on and off is adopted. The order change unit 47B advances the order of setting the guide route as the distance between the parking position and the getting-in/getting-out area increases.

According to such a configuration, the order of setting the guide route is advanced as the distance between the parking position and the getting-in/getting-out area becomes longer. Thus, it is possible to facilitate solution of the situation where the distance becomes longer and the guide routes are likely to overlap each other and are difficult to be set.

(1i) In one aspect of the present disclosure, a time period is adopted as the circumstance parameter. The order change unit 47B changes whether the order is set by giving priority to the exiting or the order is set by giving priority to the entering, in accordance with the time period.

According to such a configuration, whether to prioritize entering or exiting is changed in accordance with the time period, so it is possible to set the order with a simple configuration without monitoring the number of vehicles requesting to enter or unloaded.

(1j) In one aspect of the present disclosure, the count order change count indicating the number of times of skipping the setting order of the guide route is recorded in the order table 53B, and the order change count is adopted as the circumstance parameter. The number monitoring unit 47C monitors the order change count. When the order change count is equal to or greater than a threshold for the number of vehicles set in advance, the order change unit 47B advances the order of setting the guide route of the autonomous vehicle 18.

According to such a configuration, when the order change count is equal to or greater than the threshold for the number of vehicles, the order in which the guide route of the autonomous vehicle 18 is set is advanced. Thus, it is possible to reduce the likelihood that there is the autonomous vehicle 18 for which the guide route is not set for a long time.

(1k) In one aspect of the present disclosure, the priority recording unit 47D is configured to record the autonomous vehicle 18 for which setting the guide route is not possible and the priority in association with each other. The route generation unit 47A sets the guide route in accordance with the priority, and the order change unit 47B changes the priority in accordance with the circumstance parameter.

According to such a configuration, it is possible to change the order by changing the priority.

(1l) In one aspect of the present disclosure, the route generation unit 47A (guide setting unit) is configured to determine whether setting the guide route for the autonomous vehicle 18 is possible.

According to such a configuration, it is possible to execute various processes in accordance with whether setting the guide route for the autonomous vehicle 18 is possible.

(1m) In one aspect of the present disclosure, the route generation unit 47A (guide calculation unit) is configured to calculate the guide route of the autonomous vehicle 18 to avoid the guide route already set at a time when the guide route of the autonomous vehicle 18 is calculated.

According to such a configuration, it is possible to generate a new guide route for the autonomous vehicle 18 to avoid the guide route that has already been set.

### 2. OTHER EMBODIMENTS

Although the embodiment of the present disclosure has been described above, the present disclosure is not limited to the above-described embodiment, and can be realized in various modifications.

(2a) In the above embodiment, when the management device 39 sets the guide route, the guide route that has already been set is not changed, but the present disclosure is not limited to this. For example, when the priority condition is changed, the traveling autonomous vehicle 18 may be stopped and the guide route of the stopped autonomous vehicle 18 may be reset as necessary.

(2b) In the above embodiment, the rank is adopted as the priority, and the priority when the guide route is set in accordance with the conditions is changed, but the present disclosure is not limited to this. For example, the score may be adopted as the priority, the score may be increased or decreased in accordance with the conditions, and the order of setting the guide route may be set in accordance with the score.

(2c) In the above embodiment, the guide routes are set so as not to overlap each other, and the guide routes are calculated again in accordance with the order recorded in the order table 53B for multiple autonomous vehicles 18 for which calculation of a non-overlapping guide routes is not possible. That is, it is configured so that setting is made in accordance with the calculation order, but the present disclosure is not limited to this. For example, the guide routes that do not overlap each other may be set in a manner that a guide route is calculated by allowing duplication and overlaps with the guide route with a higher rank, and the guide route with a lower rank is deleted, in accordance with the rank in the order table 53B.

(2d) The control unit 47 and the method executed by the control unit 47 in the management device 39 described in the present disclosure may be realized by a dedicated computer provided by including a processor and a memory programmed to perform one or multiple functions embodied by a computer program. Alternatively, the control unit 47 and the method thereof described in the present disclosure may be realized by a dedicated computer provided by including a processor with one or more dedicated hardware logic circuits.

Alternatively, the control unit 47 and the method thereof described in the present disclosure may be realized by one or more dedicated computers configured by a combination of a processor and a memory programmed to perform one or multiple functions and a processor configured by one or more hardware logic circuits. The computer program may also be recorded in a computer readable non-transitory tangible recording medium, as computer executable instructions. The method for realizing the functions of each unit included in the control unit 47 does not necessarily include software, and all the functions may be realized by using one or multiple pieces of hardware.

(2e) The multiple functions of one constituent element in the above embodiments may be realized by multiple constituent elements, or a function of one constituent element may be realized by multiple constituent elements. Multiple functions belonging to multiple constituent elements may be realized by one constituent element, or one function realized by multiple constituent elements may be realized by one constituent element. A portion of the configuration of the above embodiment may be omitted. At least a portion of the configuration of the above embodiment may be added to or substituted for the configuration of the other embodiment.

(2f) The present disclosure can be realized in various forms such as a system including the management device 39 as a constituent element, a program for causing a computer to function as the management device 39, and a non-transitory tangible storage medium such as a semiconductor memory in which this program is recorded, a parking assistance method, and an order setting method, in addition to the management device 39 described above.

1. A parking assistance device configured to assist in parking a plurality of autonomous vehicles in a parking lot, each of the plurality of autonomous vehicles being capable of performing autonomous driving in accordance with a guide route to a target position in the parking lot, the device comprising:
an order table configured to record an order of setting the guide routes for the plurality of autonomous vehicles;
a guide calculation unit configured to calculate the guide routes for the autonomous vehicles;
a re-calculation unit configured to re-calculate, in accordance with the order recorded in the order table, the guide routes for vehicles among the autonomous vehicles for which the guide routes not overlapping with each other cannot be calculated;
a guide setting unit configured to:
set the guide routes for vehicles among the autonomous vehicles for which the guide routes not overlapping with each other can be calculated; and
not set the guide routes for the vehicles for which the guide routes not overlapping with each other cannot be calculated;
a route transmission unit configured to transmit the set guide routes to the autonomous vehicles; and
an order change unit configured to change the order recorded in the order table in accordance with a circumstance parameter indicative of at least one of a circumstance on the parking lot or a circumstance on each of the autonomous vehicles, wherein
the order change unit is configured to adopt, as the circumstance parameter, an unset time indicative of a waiting time during which the guide route for each of the autonomous vehicles cannot be set, and
the order change unit is configured to advance the order of setting the guide route for an autonomous vehicle when the unset time for the autonomous vehicle is equal to or greater than a predetermined time threshold.

2. The parking assistance device according to claim 1, wherein
the time threshold is a first time threshold,
the order change unit is configured to set, as the circumstance parameter, a second time threshold having a value greater than the first time threshold, and
the order change unit is configured to set the order of setting the guide routes such that the guide route for an autonomous vehicle is set first when the unset time for the autonomous vehicle is equal to or greater than the second time threshold.

3. The parking assistance device according to claim 1, wherein
the order change unit is configured to adopt, as the circumstance parameter, an exiting standby time indicative of a waiting time during which the guide route for each of requesting vehicles among the autonomous vehicles that request to exit the parking lot cannot be set, and
the order change unit is configured to advance the order of setting the guide route for a requesting vehicle when the exiting standby time for the requesting vehicle is equal to or greater than a predetermined time threshold.

4. The parking assistance device according to claim 1, wherein
identification information indicating whether each of the autonomous vehicles is a vehicle requesting to enter the parking lot or a vehicle requesting to exit the parking lot is recorded in the order table, and
the order change unit is configured to:
adopt, as the circumstance parameter, a number of the autonomous vehicles requesting to exit and a number of the autonomous vehicles requesting to enter;
advance the order of setting the guide routes for the autonomous vehicles having a greater number.

5. The parking assistance device according to claim 1, wherein
identification information indicating whether each of the autonomous vehicles is a vehicle requesting to enter the parking lot or a vehicle requesting to exit the parking lot is recorded in the order table, and
the order change unit is configured to:
adopt a number of the autonomous vehicles requesting to exit and a number of the autonomous vehicles requesting to enter, as the circumstance parameter;
when the number of the autonomous vehicles requesting to exit is greater than the number of the autonomous vehicles requesting to enter, advance the order of setting the guide routes for the autonomous vehicles requesting to exit; and
when the number of the autonomous vehicles requesting to enter is greater than the number of the autonomous vehicles requesting to exit, advance the order of setting the guide routes for the autonomous vehicles requesting to enter.

6. The parking assistance device according to claim 1, wherein
identification information indicating whether each the autonomous vehicles is a vehicle requesting to enter the parking lot or a vehicle requesting to exit the parking lot is recorded in the order table, and
the order change unit is configured to:
adopt an occupancy rate of the parking lot as the circumstance parameter;
when the occupancy rate is equal to or greater than a predetermined reference value, advance the order of setting the guide routes for the autonomous vehicles requesting to exit; and
when the occupancy rate of the parking lot is smaller than the reference value, advance the order of setting the guide routes for the autonomous vehicles requesting to enter.

7. The parking assistance device according to claim 1, wherein
a parking position assigned to each of the autonomous vehicles in a parking area is recorded in the order table, and
the order change unit is configured to:
adopt, as the circumstance parameter, the parking position assigned to each of the autonomous vehicles in the parking area and a distance to the parking position from a getting-in/getting-out area where a user gets on and off; and
advance the order of setting the guide route for an autonomous vehicle in accordance with the distance for the autonomous vehicle.

8. The parking assistance device according to claim 1, wherein
identification information indicating whether each of the autonomous vehicles is a vehicle requesting to enter the parking lot or a vehicle requesting to exit the parking lot is recorded in the order table, and
the order change unit is configured to:
adopt a time of day as the circumstance parameter; and
change the order by giving a priority to the vehicle requesting to exit or the vehicle requesting to enter depending on the time of day.

9. The parking assistance device according to claim 1, wherein
an order change count indicative of a number of times of skipping the order of setting the guide route for each of the plurality of autonomous vehicles is recorded in the order table,
the parking assistance device is configured to further comprise a number monitoring unit configured to monitor the order change count, and
the order change unit is configured to:
adopt the order change count as the circumstance parameter; and
advance the order of setting the guide route for an autonomous vehicle when the order change count for the autonomous vehicle is equal to or greater than a predetermined threshold number.

10. The parking assistance device according to claim 1, further comprising:
a priority recording unit configured to record each of the autonomous vehicles for which the guide route cannot be set and a priority assigned to each of the autonomous vehicles in association with each other, wherein
the re-calculation unit is configured to calculate each of the guide routes in accordance with the priority, and
the order change unit is configured to change the priority in accordance with the circumstance parameter.

11. The parking assistance device according to claim 1, wherein
the guide setting unit is configured to determine whether the guide routes for the autonomous vehicles can be set.

12. The parking assistance device according to claim 1, wherein
the guide calculation unit is configured to calculate the guide routes for the autonomous vehicles to avoid overlapping with the guide routes that have been already set at a time of calculating.

13. A parking assistance method performed by a parking assistance device configured to assist in parking a plurality of autonomous vehicles in a parking lot, each of the plurality of autonomous vehicles being configured to perform autonomous driving in accordance with a guide route to a target position in the parking lot, the method comprising:
calculating the guide routes for the autonomous vehicles;
re-calculating, in an order recorded in an order table, the guide routes for vehicles among the autonomous vehicles for which the guide routes not overlapping with each other cannot be set, the order table being configured to record the order of setting the guide routes for the autonomous vehicles;
setting the guide routes for vehicles among the autonomous vehicles for which the guide routes not overlapping with each other can be set and not setting the guide routes for the vehicles for which the guide routes not overlapping with each other cannot be set;
transmitting the set guide routes to the autonomous vehicles; and
changing the order recorded in the order table in accordance with a circumstance parameter indicative of at least one of a circumstance on the parking lot and a circumstance on each of the autonomous vehicles, wherein
an unset time indicative of a waiting time during which the guide route for each of the autonomous vehicles cannot be set is adopted as the circumstance parameter, and
changing the order further includes advancing the order of setting the guide route for an autonomous vehicle when the unset time for the autonomous vehicle is equal to or greater than a predetermined time threshold.

14. A non-transitory, computer readable tangible storage medium storing a parking assistance program executed by a computer of a parking assistance device configured to assist in parking a plurality of autonomous vehicles in a parking lot, each of the plurality of autonomous vehicles being configured to perform autonomous driving in accordance with a guide route to a target position in the parking lot, the parking assistance program, when executed by the computer, causing the computer to perform:
calculating the guide routes for the autonomous vehicles;
re-calculating the guide routes for vehicles among the autonomous vehicles for which the guide routes not overlapping with each other cannot be set in accordance with an order recorded in an order table, the order table being configured to record the order of setting the guide routes for the autonomous vehicles;
setting the guide routes for vehicles among the autonomous vehicles for which the guide routes not overlapping with each other can be set and not setting the guide routes for the vehicles for which the guide routes not overlapping with each other cannot be set;
transmitting the set guide routes to the autonomous vehicles; and
changing the order recorded in the order table in accordance with a circumstance parameter indicative of at least one of a circumstance on the parking lot and a circumstance on each of the autonomous vehicles, wherein
an unset time indicative of a waiting time during which the guide route for each of the autonomous vehicles cannot be set is adopted as the circumstance parameter, and
the program further causes the computer to perform advancing the order of setting the guide route for an autonomous vehicle when the unset time for the autonomous vehicle is equal to or greater than a predetermined time threshold.
